(19) United States
(12) Patent Application Publication
(10) Pub. No.: US 2022/0405512 A1
(43) Pub. Date: Dec. 22, 2022

(54) METHOD AND APPARATUS FOR DETECTING GAME CURRENCY STATE, ELECTRONIC DEVICE AND STORAGE MEDIUM

(71) Applicant: SENSETIME INTERNATIONAL PTE. LTD., Singapore (SG)

(72) Inventors: Miao OUYANG, Singapore (SG); Xinxin WANG, Singapore (SG)

(21) Appl. No.: 17/363,287

(22) Filed: Jun. 30, 2021

Related U.S. Application Data
(63) Continuation of application No. PCT/IB2021/055669, filed on Jun. 25, 2021.

(30) Foreign Application Priority Data
Jun. 21, 2021 (SG) 10202106733W

(51) Int. Cl. G06K 9/00; G06K 9/62; G06K 9/20; G07F 17/32

(52) U.S. Cl. CPC G06K 9/00771; G06K 9/6201; G06K 9/2054; G07F 17/3241; G07F 17/322; G06K 2009/6213; H04N 5/247

(57) ABSTRACT

Provided are a method and apparatus for detecting a game currency state, an electronic device, and a computer-readable storage medium. The method includes the following. An original image frame and an image frame sequence of a scene of a game table in a halt state are acquired. Multiple regions for placing game currency are provided on the game table, and the original image frame is acquired when placement of the game currency is completed. In response to determining, based on the image frame sequence and the original image frame, that game currency information of a first region among the multiple regions is changed, game currency alert information is output. In response to recognizing, based on the image frame sequence, that a game currency operating object associated with a preset object appears in the first region, process alert information is output.

### CROSS-REFERENCE TO RELATED APPLICATION

The present application is a continuation of International Application No. PCT/IB2021/055669, filed on Jun. 25, 2021, which claims priority to Singapore Patent Application No. 10202106733 W, filed to the Singapore Patent Office on 21 Jun. 2021 and entitled “METHOD AND APPARATUS FOR DETECTING GAME CURRENCY STATE, ELECTRONIC DEVICE, AND STORAGE MEDIUM”. The contents of International Application No. PCT/IB2021/055669 and Singapore Patent Application No. 10202106733 W are incorporated herein by reference in their entireties.

### BACKGROUND

For each round of game on a game table, before the game starts, a player needs to place game currency in advance in a game currency region for game currency calculation after a game result comes out. After the game starts, no one can remove or add game currency from/to a game currency region, and after the game result comes out, a game controller needs to regulate the game currency in the game currency region according to the game result. Before the game result comes out, if the game controller and a participant remove or add game currency from/to the game currency region and cause a game currency abnormality, a game rule is broken, and loss may be caused to a recreation place or the player. At present, a game currency state is usually determined by manually supervising a game process, which may likely miss game currency abnormalities.

### SUMMARY

The disclosure relates to a computer vision technology, and particularly to a method and apparatus for detecting a game currency state, an edge Artificial Intelligence (AI) node, and a storage medium.

The embodiments of the disclosure provide a method for detecting a game currency state, including: acquiring an original image frame and acquiring an image frame sequence of a scene of a game table in a halt state, wherein a plurality of regions for placing game currency are provided on the game table, and the original image frame is acquired when placement of the game currency is completed; in response to determining, based on the image frame sequence and the original image frame, that game currency information of a first region among the plurality of regions is changed, outputting game currency alert information; and in response to recognizing, based on the image frame sequence, that a game currency operating object associated with a preset object appears in the first region, outputting process alert information.

The embodiments of the disclosure provide an apparatus for detecting a game currency state, which may include an acquisition module, a first output module, and a second output module.

The acquisition module is configured to acquire an original image frame and acquire an image frame sequence of a scene of a game table in a halt state, wherein a plurality of regions for placing game currency are provided on the game table, and the original image frame is acquired when placement of the game currency is completed. The first output module may be configured to: in response to determining, based on the image frame sequence and the original image frame, that game currency information of a first region among the plurality of regions is changed, output game currency alert information. The second output module is configured to: in response to recognizing a game currency operating object associated with a preset object in the first region based on the image frame sequence, output process alert information.

The embodiments of the disclosure provide an apparatus for detecting a game currency state, including: a processor; and a memory configured to store instructions which, when being executed by the processor, cause the processor to carry out the following: acquiring an original image frame and acquiring an image frame sequence of a scene of a game table in a halt state, wherein a plurality of regions for placing game currency are provided on the game table, and the original image frame is acquired when placement of the game currency is completed; in response to determining, based on the image frame sequence and the original image frame, that game currency information of a first region among the plurality of regions is changed, outputting game currency alert information; and in response to recognizing, based on the image frame sequence, that a game currency operating object associated with a preset object appears in the first region, outputting process alert information.

The embodiments of the disclosure provide an electronic device, which includes a memory and a processor. The memory is configured to store a computer program. The processor is configured to execute the computer program stored in the memory to implement the method for detecting a game currency state.

The embodiments of the disclosure provide a non-transitory computer-readable storage medium, which may store a computer program that, when being executed by a processor, implements a method for detecting a game currency state, the method including: acquiring an original image frame and acquiring an image frame sequence of a scene of a game table in a halt state, wherein a plurality of regions for placing game currency are provided on the game table, and the original image frame is acquired when placement of the game currency is completed; in response to determining, based on the image frame sequence and the original image frame, that game currency information of a first region among the plurality of regions is changed, outputting game currency alert information; and in response to recognizing, based on the image frame sequence, that a game currency operating object associated with a preset object appears in the first region, outputting process alert information.

### BRIEF DESCRIPTION OF THE DRAWINGS

FIG. 1 illustrates a schematic structural diagram of an optional system for detecting a game currency state according to an embodiment of the disclosure.

FIG. 2 illustrates a flowchart of an optional method for detecting a game currency state according to an embodiment of the disclosure.

FIG. 3 illustrates a flowchart of an optional method for detecting a game currency state according to an embodiment of the disclosure.

FIG. 4 illustrates a flowchart of an optional method for detecting a game currency state according to an embodiment of the disclosure.

FIG. 5 illustrates a flowchart of an optional method for detecting a game currency state according to an embodiment of the disclosure.

FIG. 6 illustrates a flowchart of an optional method for detecting a game currency state according to an embodiment of the disclosure.

FIG. 7 illustrates a flowchart of an optional method for detecting a game currency state according to an embodiment of the disclosure.

FIG. 8 illustrates a flowchart of an optional method for detecting a game currency state according to an embodiment of the disclosure.

FIG. 9 illustrates a flowchart of an optional method for detecting a game currency state according to an embodiment of the disclosure.

FIG. 10 illustrates a flowchart of an optional method for detecting a game currency state according to an embodiment of the disclosure.

FIG. 11 illustrates a flowchart of an optional method for detecting a game currency state according to an embodiment of the disclosure.

FIG. 12 illustrates a schematic structural diagram of an optional apparatus for detecting a game currency state according to an embodiment of the disclosure.

FIG. 13 illustrates a schematic structural diagram of an optional electronic device according to an embodiment of the disclosure.

### DETAILED DESCRIPTION

For making the objectives, technical solutions and advantages of the disclosure clearer, the disclosure will further be described below in combination with the drawings in detail. The described embodiments should not be considered as limitation to the disclosure. All other embodiments obtained by those of ordinary skill in the art without creative work shall fall within the scope of protection of the disclosure.

“Some embodiments” involved in the following descriptions describes a subset of all possible embodiments. However, it can be understood that “some embodiments” may be the same subset or different subsets of all the possible embodiments, and may be combined without conflicts.

Term “first/second/third” involved in the following descriptions is only for distinguishing similar objects and does not represent a specific sequence of the objects. It can be understood that “first/second/third” may be interchanged to specific sequences or orders if allowed, to implement the embodiments of the disclosure described herein in sequences different from the illustrated or described ones.

Unless otherwise defined, all technological and scientific terms used in the disclosure have meanings the same as those usually understood by those skilled in the art of the disclosure. The terms used in the disclosure are only adopted to describe the embodiments of the disclosure and not intended to limit the disclosure.

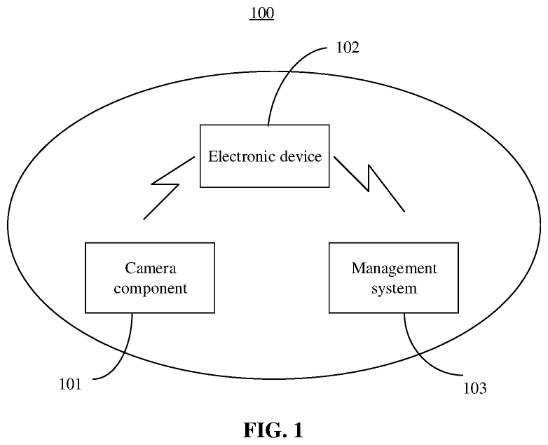

FIG. 1 illustrates a schematic structural diagram of a system for detecting a game currency state according to an embodiment of the disclosure. As illustrated in FIG. 1, the system 100 may include a camera component 101, an electronic device 102, and a management system 103. The camera component 101 is in communication connection with the electronic device 102. The management system 103 is in communication connection with the electronic device 102.

In the embodiment of the disclosure, the camera component 101 is configured to shoot a scene image of a scene of a game table, and send the scene image to the electronic device 102. The electronic device 102 is configured to perform state detection of game currency according to the scene image. In response to determining that game currency information of a first region among multiple regions of the game table is changed, the electronic device sends game currency alert information to the management system 103. In response to that the game currency information of the first region is changed, the electronic device recognizes whether a game currency operating object associated with a preset object appears in the first region. If YES, the electronic device further sends process alert information to the management system 103. The management system 103 alerts according to the game currency alert information and the process alert information. The accuracy in state detection of game currency state is improved.

In the embodiments of the disclosure, the camera component 101 may shoot scene videos of the game table in real time, or may periodically shoot scene videos of the game table according to a preset time interval, or may randomly and aperiodically shoot scene videos of the game table. A shooting manner of the camera component 101 may be set as required, and will not be limited in the embodiment of the disclosure.

In the embodiments of the disclosure, the camera component 101 may include multiple cameras, and scene videos of the game table are shot through the multiple cameras. The multiple cameras may be set with different shooting angles, so that the camera component 101 can shoot the scene of the game table scene at multiple angles.

In the embodiments of the disclosure, the electronic device 102 may be implemented as an edge AI node. Each intelligent game table corresponds to an edge AI node. Multiple edge AI nodes are in communication connection with a cloud end, and has configuration to be updated through the cloud end, and perform state detection of game currency based on updated configuration.

In the embodiments of the disclosure, the management system 103 may include a display device. The display device is configured to display multiple game region Identifier (IDs) of the game table, an alerting reason, game state information, etc.

In some embodiments of the disclosure, the management system 103 may further include at least one of a sound production apparatus, a light emitting apparatus, a vibration apparatus, etc. An alert is given through at least one of these apparatuses. For example, when the game table makes an alert, a player is prompted through the sound production apparatus.

In the embodiments of the disclosure, the camera component 101, the electronic device 102, and the management system 103 may be independent from one another, or may be integrated together. For example, the camera component 101 is integrated with the electronic device 102, or, the electronic device 102 is integrated with the management system 103. No limitation is made thereto in the embodiments of the disclosure.

A method for detecting a game currency state provided in the embodiments of the application will be described below. According to the method, state detection may be performed on game currency on a game table in a halt state, and an alert is given in response to that the game currency is changed. The efficiency in state detection of game currency is improved.

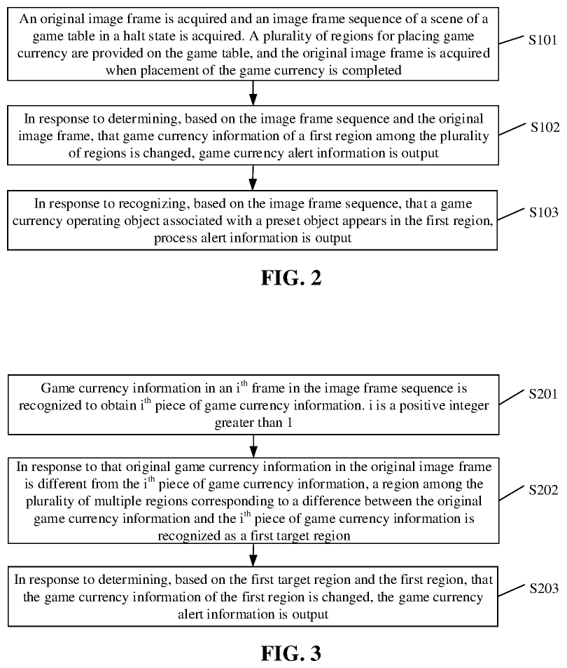

In embodiments of the disclosure, provided is a method for detecting a game currency state. As illustrated in FIG. 2, the method may include S101 to S103.

In S101, an original image frame is acquired and an image frame sequence of a scene of a game table in a halt state is acquired. A plurality of regions for placing game currency are provided on the game table, and the original image frame is acquired when placement of the game currency is completed.

In the embodiments of the disclosure, an electronic device may divide a game into different game stages, and set corresponding game states for the different game stages. As such, different state determination manners may be set for the different game states to improve the flexibility in state determination.

In the embodiments of the disclosure, a game on the game table may be Baccarat, or may be Golden Flower, Fishing Joy, Texas Poker, one-arm bandit, Five Card Stud, Pai Gow, Landlords, etc. The game on the game table may be a card game or a non-card game. In the following embodiments, descriptions will be made with the card game as an example.

In the embodiments of the disclosure, the game state may at least include: a game currency placement state, a gaming state, and a game currency payout state. In the game currency placement state, each game participant may place game currency into or remove game currency from a corresponding game currency region to adjust a game currency value. The game participant includes a game controller and multiple players. In the gaming state, the game controller starts dealing cards. After a game result comes out, the game currency payout state is entered. In the game currency payout state, the game controller may operate game currency in each game currency region, for example, removing the game currency or placing game currency. Here, the game controller may be a real manager, or may be a management robot.

It is to be noted that, in any game state, the electronic device may switch the present game state to a halt state in response to detecting an irregular operation in a game process, such as a dealing sequence error and a game currency placement region error. In the halt state, the electronic device needs to continue determining a state of the game process. For example, when game currency placed in an incorrect region is recovered to a correct region during state determination, the electronic device may switch the halt state back to the gaming state.

In the embodiments of the disclosure, after receiving a real-time video frame sequence shot by a camera component, the electronic device may acquire the original image frame and the image frame sequence in the halt state from the real-time video frame sequence.

In some embodiments of the disclosure, the camera component includes multiple cameras, and the multiple cameras may shoot multiple real-time video frame sequences. In such case, the electronic device may synthesize the multiple real-time video frame sequences according to a temporal order to obtain a real-time image frame sequence, and then acquire the original image frame and the image frame sequence in the halt state from the real-time image frame sequence.

In some embodiments of the disclosure, the operation that the multiple real-time video frame sequences are synthesized includes that: video frames in the multiple real-time video frame sequences are stitched. For example, in the multiple video frames, a left-upper region is occluded in some video frame, and the right side part is occluded in some video frames. The electronic device may stitch the multiple real-time video frame sequences to obtain an occlusion-free real-time image frame sequence.

In the embodiments of the disclosure, the multiple regions for placing the game currency are provided on the game table. The multiple regions include a first region and a second region. Game currency in the second region does not affect payout of the game. Game currency in the first region is a basis for payout of the game. After the game currency placement state is ended, the game currency in the first region should be kept unchanged until the payout state is entered.

In S102, in response to determining, based on the image frame sequence and the original image frame, that game currency information of a first region among the plurality of regions is changed, game currency alert information is output.

In the embodiments of the disclosure, after acquiring the image frame sequence and the original image frame, the electronic device may sequentially compare image frames in the image frame sequence to the original image frame, and in response to determining that the game currency information of the first region among the plurality of regions is changed, output the game currency alert information to instruct, through the game currency alert information, the game table to give an alert. The game currency alert information is configured to instruct the game table to give a game currency alert.

In some embodiments of the disclosure, the electronic device may compare game currency information in the image frame sequence to game currency information in the original image frame. In response to that the game currency information in the image frame sequence is different from the game currency information in the original image frame, the electronic device recognizes whether a region in which the game currency information is changed is the first region. In response to that the region in which the game currency is changed is the first region, the electronic device outputs the game currency alert information.

In some embodiments of the disclosure, the electronic device may recognize the first region in the image frame sequence and the original image frame respectively, acquire game currency information of the first region in the image frame sequence and game currency information of the first region in the original image frame, and in response to that the game currency information of the first region in the image frame sequence is different from the game currency information of the first region in the original image frame, output the game currency alert information.

In the embodiments of the disclosure, the electronic device may sequentially compare each frame in the image frame sequence to the original image frame, and in response to that game currency information of the first region in a certain frame is different from the game currency information of the first region in the original image frame, determine that the game currency information of the first region is changed. Alternatively, the game currency information of the first region may be determined to be changed, in response to that game currency information of the first region is kept unchanged for a preset number of frames starting from the certain frame in the image frame sequence. No limitation is set in the embodiments of the disclosure.

In the embodiments of the disclosure, the game currency information includes a game currency amount and/or a game currency value. Here, difference in the game currency amount includes increase of the game currency amount or decrease of the game currency amount, and difference in the game currency value includes increase in the game currency value or decrease in the game currency value.

Exemplarily, the value of the game currency may be distinguished by color, and different colors correspond to different values. In such case, the electronic device may determine the game currency information of the first region through the amount and color of the game currency in the first region.

In some embodiments of the disclosure, the game currency alert information may include an alert reason and an alert manner. The alerting reason may include a game currency increase or a game currency decrease. The alert manner may include at least one of displaying the alert reason on a display device, emitting alerting light through a light emitting apparatus, producing an alerting tone through a sound production apparatus, generating an alerting vibration in a vibration manner, etc. No limitation is set in the embodiments of the disclosure.

In some embodiments of the disclosure, the first region includes multiple regions, each corresponding to a game participant. The game currency alert information may further include first region information. A corresponding relationship between a region where game currency is changed and a game participant is indicated through the first region information.

Exemplarily, the game table may provide positions for four players, i.e., player A, player B, player C, and player D respectively. The first region on the game table includes four regions, i.e., region A, region B, region C, and region D respectively. After determining that game currency in the region A is changed, the electronic device outputs alert information to instruct, through the alert information, an indicator light corresponding to the player A to emit light to prompt player A that the game currency in the region A corresponding the player A is changed.

In S103, in response to recognizing, based on the image frame sequence, that a game currency operating object associated with a preset object appears in the first region, process alert information is output.

In the embodiments of the disclosure, after outputting the game currency alert information in response to determining that the game currency information of the first region is changed, the electronic device may recognize whether the game currency operating object associated with the preset object appears in the first region in the image frame sequence, and if YES, output the process alert information.

In the embodiments of the disclosure, the preset object may be a role of the game controller, a role of a neutral Non-Player Character (NPC), and the game currency operating object may be a body part of a game controller or an object used by the game controller to operate the game currency, such as a hand of a human body or a handheld part. No limitation is set in the embodiments of the disclosure.

Exemplarily, when the preset object is a person, the face may be associated to a body part (for example, a hand) thereof. The body part is associated to a face ID of the preset object to obtain the hand associated with the preset object. Correspondingly, a hand of each player (another object) participating in the game is also correspondingly associated with the face of the player.

In the case where the electronic device recognizes the image frame sequence, if an association between some one's hand and game currency is recognized, for example, it is recognized that some one's hand is operating the game currency in a placement region of the game currency, the electronic device may determine a face associated with the hand at first. When it is recognized that the hand belongs to the preset object, it is determined that the game currency operating object associated with the hand in the first region is the hand of the preset object.

In some embodiments of the disclosure, the electronic device may further output the process alert information in response to recognizing, based on the image frame sequence, that the game currency operating object associated with the preset object in a preset direction appears in the first region.

It is to be noted that the game participant needs to operate the game currency in the first region through the game currency operating object (such as the body part), such as the hand, to change the game currency information of the first region. In such case, the body part of the game participant may appear in the first region in the image frame sequence. Since different game participants are at different positions of the game table, operation directions of different game participants are different. Here, the preset direction is a direction of a body part of the game controller. When recognizing that the game currency operating object associated with the preset object appears in the first region, the electronic device may determine that the game controller operates the game currency in the first region to change in the game currency information of the first region.

In the embodiments of the disclosure, if the electronic device determines that the game controller operates the game currency in the first region, it indicates that the game controller starts a game currency payout operation. A normal payout operation should be performed in a payout state after the gaming state is smoothly ended and the game result comes out. Therefore, a payout operation in the halt state is a payout operation performed after an exception occurs to the game process. The electronic device may output the process alert information.

In the embodiments of the disclosure, the process alert information is configured to represent a flow exception of the present game. Here, the electronic device outputs process alert information once in each round of game. That is, after the process alert information is output once, if it is detected again, in the halt state in the game process, that the game controller operates the game currency in the first region to change the game currency information of the first region, the electronic device may not output any process alert information.

It can be understood that the electronic device may determine whether the game currency information of the first region is changed in the halt state, and in response to that the game currency information of the first region is changed, output the game currency alert information. Moreover, in response to that the game currency information of the first region is changed by an operation of the game currency operating object associated with the preset object, it is determined that the game controller performs the game currency payout operation after the exception occurs to the game process, and the process alert information is output. Therefore, the accuracy in state detection of game currency in the halt state is improved, and efficient management over the game process is implemented.

In some embodiments of the disclosure, implementation of the operation in S102 that the game currency alert information is output in response to determining, based on the image frame sequence and the original image frame, that the game currency information of the first region among the plurality of regions is changed, as illustrated in FIG. 3, may include S201 to S203.

In S201, game currency information in an i^{th} frame in the image frame sequence is recognized to obtain i^{th} piece of game currency information. i is a positive integer greater than 1.

In the embodiments of the disclosure, the electronic device may sequentially compare each frame in the image frame sequence to the original image frame to further determine whether the game currency information of the first region is changed.

In the embodiments of the disclosure, every time of acquiring a frame, the electronic device may recognize game currency information in the frame, and compare the game currency information in the frame to the game currency information in the original image frame. After acquiring the i^{th} frame, the electronic device may recognize the game currency information in the i^{th} frame to obtain the i^{th} piece of game currency information.

In S202, in response to that original game currency information in the original image frame is different from the i^{th} piece of game currency information, a region among the plurality of multiple regions corresponding to a difference between the original game currency information and the i^{th} piece of game currency information is recognized as a first target region.

In the embodiments of the disclosure, the electronic device compares the i^{th} piece of game currency information to the original game currency information after obtaining the i^{th} piece of game currency information. The original game currency information is game currency information recognized from the original image frame. In response to determining that the i^{th} piece of game currency information is different from the original game currency information, the electronic device determines the region corresponding to the difference in game currency information between the i^{th} frame and the original image frame as the first target region.

In the embodiments of the disclosure, the electronic device may recognize multiple game currency regions (i.e., the multiple regions) in the i^{th} frame and the multiple game currency regions in the original image frame, acquire game currency information of each game currency region among the multiple game currency regions, compare the game currency information of the multiple game currency regions in the frame to the game currency information of the multiple game currency regions in the original image frame, and determine the region corresponding to the difference in game currency information as the first target region.

In S203, in response to determining, based on the first target region and the first region, that the game currency information of the first region is changed, the game currency alert information is output.

In the embodiments of the disclosure, after determining the first target region, the electronic device may determine, based on the first target region and the first region, whether the game currency information of the first region is changed, and if YES, output the game currency alert information.

In some embodiments of the disclosure, the electronic device may determine that the game currency information of the first region is changed in the case that the first target region is the first region.

In some embodiments of the disclosure, implementation of the operation in S203 that the game currency alert information is output in response to determining, based on the first target region and the first region, that the game currency information of the first region is changed, as illustrated in FIG. 4, may include S301 to S303.

In S301, in response to that the first target region is the first region, (i−1)^{th} piece of game currency information in an (i−1)^{th} frame and an (i−1)^{th} change value are acquired. The (i−1)^{th} change value is configured to represent a number of continuous frames, corresponding to the (i−1)^{th} frame, in which the game currency information of the first region is changed relative to the original image frame.

In the embodiments of the disclosure, in response to determining that the first target region is the first region, the electronic device acquires game currency information, i.e., the (i−1)^{th} piece of game currency information, in the (i−1)^{th} frame and the (i−1)^{th} change value, and determines the i^{th} change value based on the (i−1)^{th} frame, the i^{th} frame, and the (i−1)^{th} change value.

It is to be noted that, after detecting for the first time that game currency information on the game table in a certain frame is changed and determining that a region of which game currency information is changed is the first region, the electronic device determines an initial change value as a change value of the frame. The initial change value represents that the frame is a first frame in which the game currency information is changed.

Here, the initial change value may be 1, or may be another value except 1. No limitation is set thereto in the embodiments of the disclosure.

In the embodiment of the disclosure, the electronic device determines an original value as the i^{th} change value in response to determining that the first target region is not the first region. The original value is configured to represent that the game currency information of the first region in the i^{th} frame is the same as the game currency information of the first region in the original image frame.

In some embodiments of the disclosure, the original value may be 0.

In S302, in response to that the i^{th} piece of game currency information is the same as the (i−1)^{th} piece of game currency information, the (i−1)^{th} change value is increased by a first preset value to obtain an i^{th} change value.

In the embodiment of the disclosure, after acquiring the (i−1)^{th} piece of game currency information and the (i−1)^{th} change value, the electronic device judges whether the (i−1)^{th} piece of game currency information is the same as the i^{th} piece of game currency information, and in response to that the (i−1)^{th} piece of game currency information is the same as the i^{th} piece of game currency information, increases the (i−1)^{th} change value by the first preset value to obtain the i^{th} change value. The first preset value may be set as required. No limitation is set thereto in the embodiments of the application.

It is to be noted that, in response to that the i^{th} piece of game currency information is the same as the (i−1)^{th} piece of game currency information, it indicates that no game currency is removed from or added to the game table, and the game currency information of the first region may not be changed. As such, in response to that the i^{th} piece of game currency information is the same as the (i−1)^{th} piece of game currency information, the electronic device may determine that the game currency information of the first region is unchanged between the (i−1)^{th} frame and the i^{th} frame.

In S303, in response to that the i^{th} change value is more than or equal to a first change threshold, it is determined that the game currency information of the first region is changed, and the game currency alert information is output.

In the embodiments of the disclosure, after obtaining the i^{th} change value, the electronic device judges whether the i^{th} change value is more than or equal to the first change threshold. In response to that the i^{th} change value is more than or equal to the change threshold, the electronic device determines that the game currency information of the first region is changed relative to the original image frame, and outputs the game currency alert information.

In the embodiments of the disclosure, after detecting that game currency information of the first region in a certain frame is changed relative to the original image frame, the electronic device needs to judge whether the number of frames in which this change is kept reaches the number of frames corresponding to the first change threshold. If YES, the electronic device determines that the game currency information of the first region is changed.

Here, the first change threshold may be set as required. No limitation is set thereto in the embodiments of the disclosure.

It can be understood that, after determining that game currency information of the first region in a certain frame is changed, the electronic device may determine that the game currency information of the first region is changed only if it is determined that this change is kept for a number of frames corresponding to the first threshold value. The accuracy in the electronic device determining that the game currency information of the first region is changed is improved.

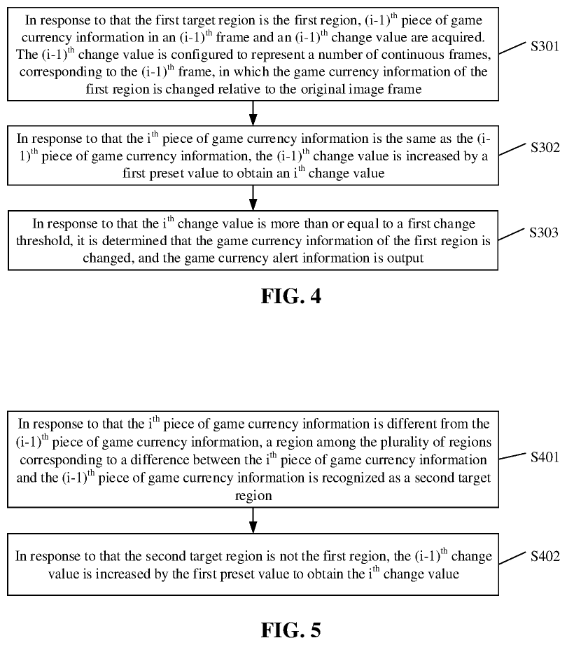

In some embodiments of the disclosure, an implementation after S301 and before S303, as illustrated in FIG. 5, may include S401 to S402.

In S401, in response to that the piece of game currency information is different from the (i−1)^{th} piece of game currency information, a region among the plurality of multiple regions corresponding to a difference between the i^{th} piece of game currency information and the (i−1)^{th} piece of game currency information is recognized as a second target region.

In the embodiments of the disclosure, after determining that the (i−1)^{th} piece of game currency information is different from the i^{th} piece of game currency information, the electronic device may recognize the region corresponding to a difference between the i^{th} piece of game currency information and the (i−1)^{th} piece of game currency information as the second target region.

In S402, in response to that the second target region is not the first region, the (i−1)^{th} change value is increased by the first preset value to obtain the i^{th} change value.

In the embodiments of the disclosure, the electronic device may determine the second target region, and judge whether the second target region is the first region. In response to that the second target region is not the first region, it indicates that the game currency information of the first region in the i^{th} frame is unchanged, and the electronic device may increase the (i−1)^{th} change value by the first preset value to obtain the i^{th} change value.

It can be understood that, in response to determining that the (i−1)^{th} piece of game currency information is different from the i^{th} piece of game currency information, the electronic device may recognize the region of which game currency information is changed. In response to that the region of which the game currency information is changed is not the first region, the electronic device determines that the game currency information of the first region in the i^{th} frame is the same as the game currency information of the first region in the (i−1)^{th} frame.

In some embodiments of the disclosure, in S304, after recognizing the region corresponding to a difference between the i^{th} piece of game currency information and the (i−1)^{th} piece of game currency information as the second target region in response to that the (i−1)^{th} piece of game currency information is different from the i^{th} piece of game currency information, the electronic device may determine an initial change value as the i^{th} change value in response to that the second target region is the first region.

In the embodiments of the disclosure, in response to determining that the second target region is the first region, the electronic device may determine that the game currency information of the first region in the i^{th} frame is different from the game currency information of the first region in the (i−1)^{th} frame. That is, the game currency information of the first region in the i^{th} frame is changed relative to the game currency information of the first region in the original image frame, and the i^{th} frame is the first frame corresponding to this change. Therefore, the electronic device may determine the i^{th} change value to be the initial change value.

Exemplarily, the initial change value is 1, the original value is 0, and the first change threshold is 19. When the electronic device sequentially acquires each frame in the image frame sequence until acquiring an eleventh frame, the electronic device detects that 11^{th} piece of game currency information is different from the original game currency information. The electronic device continues to recognize a region corresponding to the difference in game currency information as a target region. In response to determining that the target region is the first region, the electronic device determines that an 11^{th} change value is 1. Afterwards, the electronic device may obtain that a 29^{th} change value is 19 in response to detecting that game currency information of the first region in each frame from a 12^{th} frame to a 29^{th} frame is the same as the game currency information of the first region in the 11^{th} frame. In such case, the electronic device may determine that the game currency information of the first region is changed.

In some embodiments of the disclosure, an event that the original game currency information in the original image frame is different from the i^{th} piece of game currency information in the i^{th} frame includes at least one of the following: an original game currency amount in the original image frame is larger than an i^{th} game currency amount in the i^{th} frame, or an original game currency value in the original image frame is higher than an i^{th} game currency value in the i^{th} frame. The operation that the game currency alert information is output includes that: first game currency alert information is output. The first game currency alert information being configured to represent a game currency amount decrease and/or game currency value decrease of the first region.

In the embodiments of the disclosure, the electronic device determines the game currency amount decrease and/or the game currency value decrease in response to that the original game currency amount is larger than the i^{th} game currency amount and/or the original game currency value is higher than the i^{th} game currency value. Then, in response to determining that a region corresponding to the game currency amount decrease and/or the game currency value decrease is the first region, the electronic device may output the first game currency alert information to represent the game currency amount decrease and/or game currency value decrease of the first region through the first game currency alert information.

In some embodiments of the disclosure, an event that the original game currency information in the original image frame is different from the i^{th} piece of game currency information in the i^{th} frame includes at least one of the following: an original game currency amount in the original image frame is smaller than the i^{th} game currency amount in the i^{th} frame, or an original game currency value in the original image frame is lower than the i^{th} game currency value in the i^{th} frame. The operation that the game currency alert information is output includes that: second game currency alert information is output. The second game currency alert information is configured to represent a game currency amount increase and/or game currency value increase of the first region.

In the embodiments of the disclosure, the electronic device determines the game currency amount increase and/or the game currency value increase in response to that the original game currency amount is smaller than the i^{th} game currency amount and/or the original game currency value is lower than the i^{th} game currency value. Then, in response to determining that a region corresponding to the game currency amount increase and/or the game currency value increase is the first region, the electronic device may output the second game currency alert information to represent the game currency amount increase and/or the game currency value increase through the second game currency alert information.

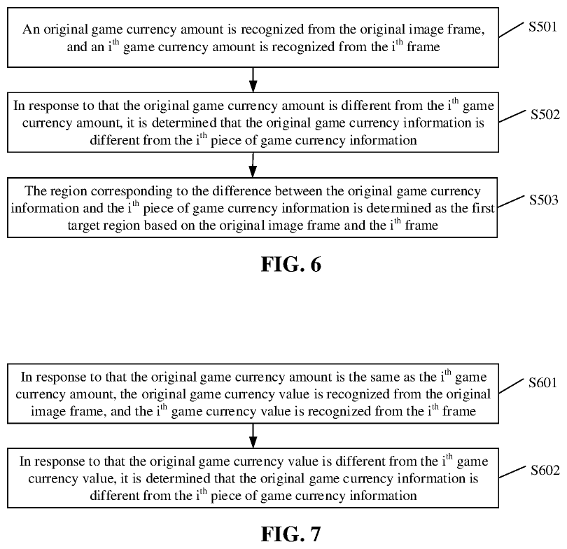

In some embodiments of the disclosure, implementation of the operation in S202 that the region corresponding to a difference between the original game currency information and the i^{th} piece of game currency information is recognized as the first target region in response to that the original game currency information in the original image frame is different from the i^{th} piece of game currency information, as illustrated in FIG. 6, may include S501 to S503.

In S501, an original game currency amount is recognized from the original image frame, and an i^{th} game currency amount is recognized from the i^{th} frame.

In the embodiments of the disclosure, the electronic device may recognize a game currency amount from the original image frame as the original game currency amount, and recognize a game currency amount from the i^{th} frame as the i^{th} game currency amount.

In S502, in response to that the original game currency amount is different from the i^{th} game currency amount, it is determined that the original game currency information is different from the i^{th} piece of game currency information.

In the embodiments of the disclosure, after obtaining the original game currency amount and the i^{th} game currency amount, the electronic device judges whether the original game currency amount is the same as the i^{th} game currency amount. In response to that the original game currency amount is different from the i^{th} game currency amount, the electronic device determines that the original game currency information is different from the i^{th} piece of game currency information.

In S503, the region corresponding to the difference between the original game currency information and the i^{th} piece of game currency information is determined as the first target region based on the original image frame and the i^{th} frame.

In the embodiments of the disclosure, after determining that the original game currency information is different from the i^{th} piece of game currency information, the electronic device may compare the original image frame to the i^{th} frame to recognize the region corresponding to the difference in game currency information as the first target region.

It can be understood that the electronic device may judge whether the original game currency amount is the same as the i^{th} game currency amount, and in response to that the original game currency amount is different from the i^{th} game currency amount, directly determine that the original game currency information is different from the i^{th} piece of game currency information, thereby rapidly determining that the game currency information of the i^{th} frame is changed.

In some embodiments of the disclosure, implementation after the operation in S501 that the original game currency amount is recognized from the original image frame and the i^{th} game currency amount is recognized from the i^{th} frame and before the operation in S503 that the region corresponding to the difference between the original game currency information and the i^{th} piece of game currency information is determined as the first target region based on the original image frame and the i^{th} frame, as illustrated in FIG. 7, may include S601 to S602.

In S601, in response to that the original game currency amount is the same as the i^{th} game currency amount, the original game currency value is recognized from the original image frame, and the i^{th} game currency value is recognized from the i^{th} frame.

In the embodiments of the disclosure, in response to determining that the original game currency amount is the same as the i^{th} game currency amount, the electronic device may recognize a game currency value from the original image frame as the original game currency value, recognize a game currency value from the i^{th} frame as the i^{th} game currency value, and judge whether the original game currency information is the same as the i^{th} piece of game currency information based on the original game currency value and the i^{th} game currency value.

In S602, in response to that the original game currency value is different from the i^{th} game currency value, it is determined that the original game currency information is different from the i^{th} piece of game currency information.

In the embodiments of the disclosure, after obtaining the original game currency value and the i^{th} game currency value, the electronic device may determine that the original game currency information is different from the i^{th} piece of game currency information in the case that the original game currency value is different from the i^{th} game currency value.

It can be understood that, in the case where the original game currency amount is the same as the i^{th} game currency amount, the electronic device may further determine that the original game currency information is different from the i^{th} piece of game currency information in response to that the original game currency value is different from the i^{th} game currency value. The accuracy of determining the game currency information is improved.

In some embodiments of the disclosure, in response to recognizing, based on the image frame sequence, that the game currency operating object associated with the preset object appears in the first region, the electronic device switches a game state from the halt state to a payout state.

In the embodiments of the disclosure, the electronic device may switch the game state from the halt state to the payout state through a Dealing Sequence (DS) module.

In the embodiments of the disclosure, in response to recognizing that the game currency operating object associated with the preset object appears in the first region, the electronic device may determine that the game controller operates, for example, removes or adds, the game currency in the first region, and then may determine that the game enters the payout state so that the game controller starts payout according to the game currency in the first region. In such case, the electronic device may perform game state switching through the DS module to switch from the halt state to the payout state. Thus, the electronic device may perform state detection on the game according to a state determination manner corresponding to the payout state.

In some embodiments of the disclosure, implementation of the operation in S103 that the process alert information is output in response to recognizing, based on the image frame sequence, that the game currency operating object associated with the preset object appears in the first region, as illustrated in FIG. 8, may include S701 to S702.

In S701, in response to detecting that the game currency operating object appears in the first region in m continuous image frames before the frame of the image frame sequence, a direction of the game currency operating object is recognized to obtain an operation direction, m being a positive integer.

In the embodiments of the disclosure, after determining that the game currency information of the first region is changed, in response to that the i^{th} change value is more than or equal to the first change threshold, the electronic device may detect whether the game currency operating object appears in the first region in the m continuous image frames before the frame. In response to that the game currency operating object appears in the first region, the electronic device recognizes the direction of the game currency operating object as the operation direction. Here, m is a positive integer greater than a first threshold, and a value of m may be set as required. No limitation is set in the embodiments of the disclosure.

In S702, in response to that the operation direction is a preset direction, it is determined that the game currency operating object associated with the preset object appears in the first region, and the process alert information is output.

In the embodiments of the disclosure, after recognizing the operation direction, the electronic device continues to judge whether the operation direction is the preset direction. In response to that the operation direction is the preset direction, the electronic device may determine that the game currency operating object associated with the preset object appears in the first region. At this point, the process alert information is output.

In the embodiments of the disclosure, the preset direction is the direction of the game currency operating object of the game controller operating the first region. Here, the preset direction may be represented by a preset range of angle, and the operation direction may be represented by an angle of the body part. Then, in response to that the angle of the body part is in the preset range of angle, the electronic device may determine that the game controller operates the game currency in the first region, and output the process alert information.

It can be understood that, in response to that the game currency in the first region is changed, the electronic device may recognize, from the m continuous image frames before the frame, whether the game currency operating object of the preset direction appears in the first region, so as to determine whether the change in the game currency information of the first region is caused by the game controller operating the game currency in the first region. If YES, the electronic device outputs the process alert information.

In some embodiments of the disclosure, implementation after the operation in S102 that the game currency alert information is output in response to determining, based on the image frame sequence and the original image frame, that the game currency information of the first region among the plurality of regions is changed, as illustrated in FIG. 3, may further include the following operation.

In S104, in response to determining, based on the image frame sequence and the original image frame, that the game currency information of the first region among the plurality of regions is unchanged, game currency alert cancellation information is output. The game currency alert cancellation information is configured to instruct the game table to cancel the game currency alert.

In the embodiments of the disclosure, after determining that the game currency information of the first region is changed and outputting the game currency alert information, the electronic device continues acquiring the image frame sequence. After the game currency alert information is output, the electronic device determines whether the game currency information of the first region in the image frame sequence is recovered to be consistent with the game currency information of the first region in the original image frame. If YES, the electronic device outputs the game currency alert cancellation information to instruct the game table to cancel the game currency alert.

Here, the alerting manner of the game table corresponds to the manner of game currency alert cancellation. For example, if the alerting manner of the game table is to display the game currency alert on a display screen, the manner of alert cancellation may be to remove the game currency alert from the display screen. If the alerting manner of the game table to vibrate for prompting, the manner of alert cancellation may be to stop vibration.

It can be understood that, if the electronic device determines that the game currency information of the first region is changed and then recovered back to the state before the change, it indicates that the game currency in the first region is removed or added, and is then recovered back to an original state again. In such case, the electronic device may output the game currency alert cancellation information to instruct the game table to cancel the game currency alert.

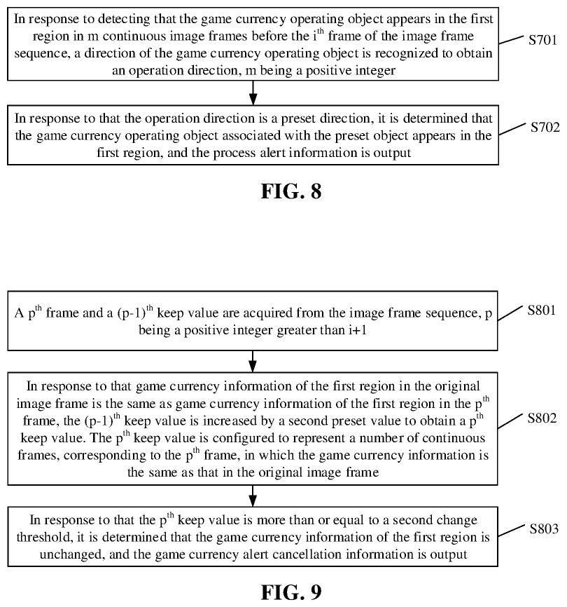

In some embodiments of the disclosure, implementation of the operation in S104 that the game currency alert cancellation information is output in response to determining, based on the image frame sequence and the original image frame, that the game currency information of the first region among the plurality of regions is unchanged, as illustrated in FIG. 9, may include the following operations.

In S801, a p^{th} frame and a (p−1)^{th} keep value are acquired from the image frame sequence, p being a positive integer greater than i+1.

In the embodiments of the disclosure, after acquiring the i^{th} frame, the electronic device continues to acquire an (i+n)^{th} image frame (i.e., the p^{th} frame) in the image frame sequence after outputting the game currency alert information in response to determining that the i^{th} change value is more than or equal to the first change threshold. n is a positive integer. The electronic device acquires the p^{th} frame and the (p−1)^{th} keep value from the image frame sequence. The (p−1)^{th} keep value is configured to represent a number of continuous frames, corresponding to the (p−1)^{th} frame, in which the game currency information is the same as that in the original image frame.

In the embodiments of the disclosure, the electronic device needs to determine whether the game currency information of the first region in the (p−1)^{th} frame is the same as the game currency information of the first region in the original image frame. If YES, the electronic device determines an initial keep value as the (p−1)^{th} keep value. If NOT, the electronic device determines an original keep value as the (p−1)^{th} keep value. The initial keep value is configured to represent a first frame in which the game currency information is recovered from the change. The original keep value is configured to represent that the game currency information is not recovered from the change. Here, p is a positive integer greater than i+1.

In some embodiments, the original keep value may be 0, and the initial keep value may be 1. No limitation is set in the embodiments of the disclosure.

In S802, in response to that game currency information of the first region in the original image frame is the same as game currency information of the first region in the p^{th} frame, the (p−1)^{th} keep value is increased by a second preset value to obtain a p^{th} keep value. The p^{th} keep value is configured to represent a number of continuous frames, corresponding to the p^{th} frame, in which the game currency information is the same as that in the original image frame.

In the embodiments of the disclosure, for the p^{th} frame, the electronic device may judge whether the game currency information of the first region in the p^{th} frame is the same as the game currency information of the first region in the original image frame. If YES, the electronic device increases the (p−1)^{th} keep value by the second preset value to obtain the p^{th} keep value.

Here, the second preset value represents that there is one more frame in which the game currency is recovered. The second preset value may be set as required. No limitation is set thereto in the embodiments of the disclosure.

In the embodiments of the disclosure, in response to determining that the game currency information of the first region in the p^{th} frame is different from the game currency information of the first region in the original image frame, the electronic device determines the original keep value as the p^{th} keep value.

In some embodiments of the disclosure, in response to that the game currency information in the p^{th} frame is the same as the original game currency information, the electronic device may determine that the game currency information of the first region in the p^{th} frame is the same as the game currency information of the first region in the original image frame.

In some embodiments of the disclosure, in response to that the game currency information in the p^{th} frame is different from the original game currency information, the electronic device may judge whether a region of which game currency information is changed is the first region in the p^{th} frame. If NOT, the electronic device determines that the game currency information of the first region in the p^{th} frame is the same as the game currency information of the first region in the original image frame.

In S803, in response to that the p^{th} keep value is more than or equal to a second change threshold, it is determined that the game currency information of the first region is unchanged, and the game currency alert cancellation information is output.

In the embodiments of the disclosure, after acquiring the p^{th} keep value, the electronic device may judge whether the p^{th} keep value is more than or equal to the second change threshold. If YES, the electronic device determines that the game currency information of the first region is unchanged, namely the change of game currency information of the first region is recovered. The electronic device outputs the game currency alert cancellation information. The second change threshold is configured to represent the number of continuous frames in which the game currency information of the first region in the p^{th} frame is the same as the game currency information of the first region in the original image frame.

It can be understood that, in the conditions of determining that the game currency information of the first region is changed, the electronic device continues to determine whether the game currency information of the first region is recovered. After game currency information of the first region in a certain frame is the same as the game currency information of the first region in the original image frame, the electronic device continues to determine whether the game currency information of the first region in a video frame after the certain frame is still the same as the game currency information of the first region in the original image frame. Until the number of continuous frames, after the certain frame, in which the game currency information is the same as the game currency information of the first region in the original image frame reaches the number of frames corresponding to the second change threshold, the electronic device determines that the game currency information of the first region is recovered. The accuracy of determining the state of the game currency information of the first region is improved.

In some embodiments of the disclosure, the electronic device may acquire at least two video frame sequences in the halt state through the camera component. Here, the camera component includes at least two cameras, and the camera component is provided on the game table. A video frame sequence may be acquired through each camera. The electronic device may synthesize the at least two video frame sequences according to a temporal order to obtain the image frame sequence in the halt state.

In the embodiments of the disclosure, the electronic device may remove occluded or unclear parts in a synthesis process to obtain an occlusion-free clear image frame sequence. The accuracy of recognizing the image frame sequence by the electronic device is improved.

The embodiments of the disclosure provide a scene of game currency state detection, which is used for a casino. The game controller is the dealer, the game table is a gaming table, and the game currency is chips. Each gaming table may be managed through a Casinos Management System (CMS). The CMS receives alert information output by the electronic device to instruct the corresponding gaming table to alert.

In the embodiments of the disclosure, there is a cloud device and multiple extensible edge AI nodes provided in the casino. Each edge AI node runs a set of intelligent casino service. On one hand, an overall progress of a game on a game table (also called a gaming table) is controlled, an irregular action of the dealer or a player is detected for state determination, such as a dealing sequence error and chips removed after card dealing is started. When an irregular action is found, an alert is given. The accuracy of game currency state detection is improved. Meanwhile, the overall game conditions (incomes and the number of tables in use) of the casino are automatically counted to assist the manager in making decisions.

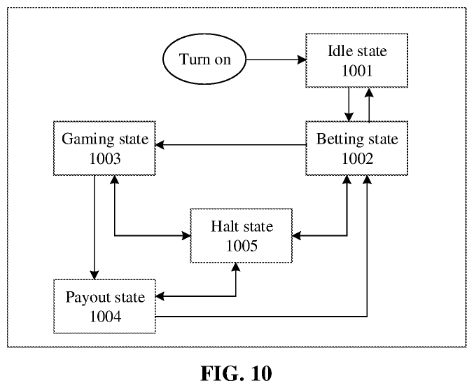

In the embodiments of the disclosure, descriptions are made taking Baccarat (a card game) as an example. FIG. 10 illustrates a diagram of game state transition. As illustrated in FIG. 10, game states include five states, i.e., an idle state 1001, a betting state 1002, a gaming state 1003, a payout state 1004, and a halt state 1005. In the betting state 1002, all players may place chips into betting regions as basis for final payout. In the gaming state 1003, the dealer (the preset object) deals cards, and the players are not allowed to change the chips placed in the other betting regions except insured regions. In the payout state 1004, a game result comes out, and the dealer starts payout for each player and the banker according to the game result and the chips in the betting regions. The halt state 1005 is a state that is entered when an abnormal operation is performed in a game process, for example, the dealer deals the cards in an incorrect sequence. In the idle state, the electronic device may not perform game currency state detection on the game process, namely no alert information is output. It is to be noted that, all the betting state 1002, the gaming state 1003, and the payout state 1004 may be switched to the halt state 1005. In the halt state 1005, the electronic device needs to perform game currency state detection on the game process.

In the embodiments of the disclosure, after acquiring three video frame sequences based on three cameras, the electronic device may synthesize the three video frame sequences into an image frame sequence, and store each frame in the image frame sequence in a queue. Here, the electronic device includes a parsing layer and a service layer. Through the parsing layer, each frame in the image frame sequence is acquired from the queue, and image recognition is performed on each frame to obtain a recognition result. Here, the recognition result may include game currency information on the game table, the player, the dealer, and body parts (game currency operating objects), such as hands or arms, of the player and the dealer. Then, the parsing layer pushes the recognition result to the service layer. The service layer performs game currency state detection according to the recognition result. For example, the game currency information on the game table is compared with game currency information on the game table before the dealer pulls the cards, to determine whether the game currency information is changed, and alert information is output according to change conditions of the game currency information. In some embodiments, the parsing layer may further place the recognition result in a cache layer for storage. When the service needs to use the recognition result of a certain frame, the recognition result of the frame is acquired from the cache.

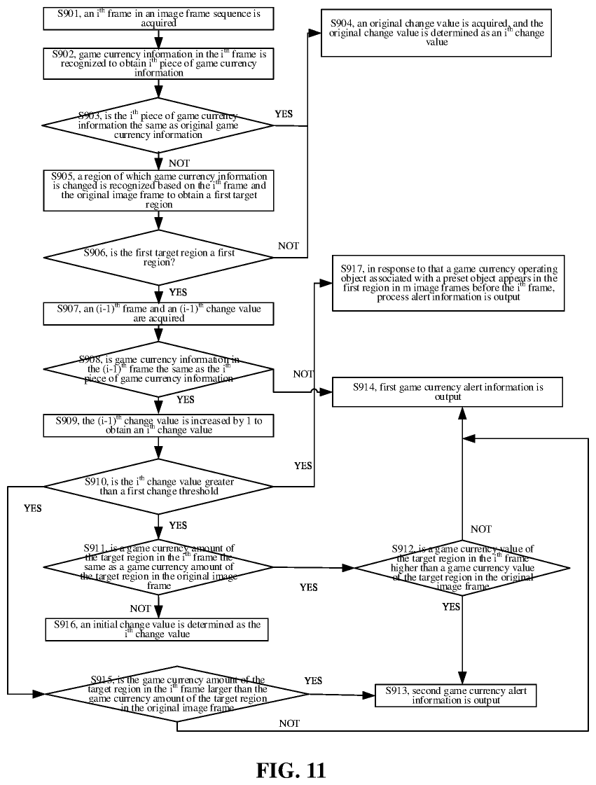

FIG. 11 illustrates a schematic flowchart of a method for detecting a game currency state. As illustrated in FIG. 11, the method may include the following operations.

In S901, an i^{th} frame in an image frame sequence is acquired.

In S902, game currency information in the i^{th} frame is recognized to obtain i^{th} piece of game currency information.

In the embodiments of the disclosure, the image frame sequence is stored in a queue. An electronic device may acquire the i^{th} frame from the queue through the parsing layer, and recognize the game currency information in the i^{th} frame to obtain the i^{th} piece of game currency information.

In the embodiments of the disclosure, after recognizing the i^{th} piece of game currency information through the parsing layer, the electronic device may store the i^{th} piece of game currency information in a cache layer.

In S903, whether the i^{th} piece of game currency information is the same as original game currency information is judged. The original game currency information is game currency information in an original image frame. If YES, S904 is executed. If NOT, S905 to S906 are executed.

In the embodiments of the disclosure, the original image frame is an image frame acquired when placement of game currency is complemented. The electronic device recognizes the original image frame through the parsing layer to obtain the game currency information in the original image frame, i.e., the original game currency information.

In S904, an original change value is acquired, and the original change value is determined as an i^{th} change value. The i^{th} change value is configured to represent the number of continuous frames corresponding to the i^{th} frame in the case that the game currency information is different.

In S905, a region of which game currency information is changed is recognized based on the i^{th} frame and the original image frame to obtain a first target region.

In S906, whether the first target region is a first region is judged. If YES, S907 to S908 are executed. If NOT, S904 is executed.

In S907, an (i−1)^{th} frame and an (i−1)^{th} change value are acquired.

In S908, whether game currency information in the (i−1)^{th} frame is the same as the i^{th} piece of game currency information is judged. If YES, S909 to S911 are executed. If NOT, S914 is executed.

In S909, the (i−1)^{th} change value is increased by 1 to obtain an i^{th} change value.

In the embodiments of the disclosure, a first preset value is 1. The electronic device increases the (i−1)^{th} change value by 1 to obtain the i^{th} change value in response to determining that the game currency information in the (i−1)^{th} frame is the same as the i^{th} piece of game currency information.

In S910, whether the i^{th} change value is greater than a first change threshold is judged. If YES, S911 to S917 are executed.

In S911, whether a game currency amount of the target region in the i^{th} frame is the same as a game currency amount of the target region in the original image frame is judged. If YES, S912 is executed. If NOT, S916 is executed.

In the embodiments of the disclosure, the electronic device may determine that the game currency information of the first region is changed in response to that the i^{th} change value is greater than the first change threshold. In such case, the electronic device may judge whether a game currency change of the first region is increase in a game currency amount and/or game currency value or decrease in the game currency amount and/or game currency value.

In the embodiments of the disclosure, the electronic device may judge whether the game currency amount of the target region in the frame is the same as the game currency amount of the target region in the original image frame. If NOT, alert information to be output may be determined according to the game currency amount increase or decrease. If YES, it indicates that a game currency value of the target region in the i^{th} frame is different from a game currency value of the target region in the original image frame. In such case, the alert information to be output needs to be determined according to the game currency value increase or decrease.

In S912, whether a game currency value of the target region in the frame is higher than a game currency value of the target region in the original image frame is judged. If YES, S913 is executed. If NOT, S914 is executed.

In S913, second game currency alert information is output.

In the embodiments of the disclosure, if the game currency value of the target region in the frame is higher than the game currency value of the target region in the original image frame, or the game currency amount of the target region in the frame is larger than the game currency amount of the target region in the original image frame, it indicates that someone continues betting to the first region after the betting to the first region with the game currency is completed which causes the game currency amount increase or value increase of the first region. In such case, the electronic device may output the second game currency alert information.

In some embodiments of the disclosure, the second game currency alert information may be late bet alert information.

In S914, first game currency alert information is output.

In the embodiments of the disclosure, if the game currency value of the target region in the i^{th} frame is lower than the game currency value of the target region in the original image frame, or the game currency amount of the target region in the i^{th} frame is smaller than the game currency amount of the target region in the original image frame, it indicates that someone removes game currency from the first region after betting to the first region with the game currency is completed, which causes the game currency amount decrease or value decrease of the first region. In such case, the electronic device may output the first game currency alert information.

In some embodiments of the disclosure, the first game currency alert information may be chip remove alert information.

In S915, whether the game currency amount of the target region in the i^{th} frame is larger than the game currency amount of the target region in the original image frame is judged. If YES, S913 is executed. If NOT, S914 is executed.

In S916, an initial change value is determined as the i^{th} change value.

In S917, in response to that a game currency operating object associated with a preset object appears in the first region in m image frames before the i^{th} frame, process alert information is output.

In some embodiments of the disclosure, the process alert information may be sequence error ignore alert information.

In the embodiments of the disclosure, the electronic device may firstly judge whether the game currency information of the first region is changed. If YES, whether the game currency amount of the first region is changed is judged at first; and if it is changed, whether the game currency amount of the first region increases or decreases. If the game currency amount increases, the second game currency alert information is output. If the game currency amount decreases, the first game currency alert information is output. If the game currency amount of the first region is unchanged, alert information is output according to the game currency value of the first region. If the game currency value increases, the second game currency alert information is output. If the game currency value decreases, the first game currency alert information is output. Moreover, if the game currency amount of the first region is changed, the electronic device further needs to detect whether the hand of the game controller appears in the first region in the image frame sequence, and if YES, outputs the process alert information. In this way, the game currency state detection accuracy is improved.

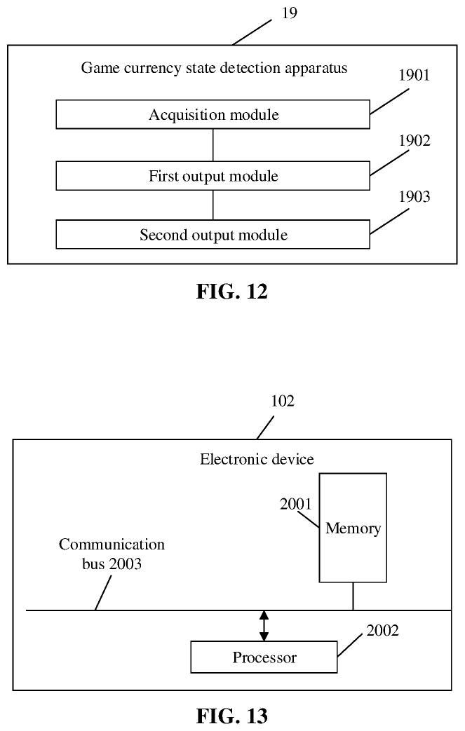

Based on the abovementioned embodiments, the embodiments of the disclosure also provide an apparatus for detecting a game currency state. As illustrated in FIG. 12, the apparatus 19 includes an acquisition module 1901, a first output module 1902, and a second output module 1903.

The acquisition module 1901 is configured to acquire an original image frame and acquire an image frame sequence of a scene of a game table in a halt state. A plurality of regions for placing game currency are provided on the game table, and the original image frame is acquired when placement of the game currency is completed.

The first output module 1902 is configured to: in response to determining, based on the image frame sequence and the original image frame, that game currency information of a first region among the plurality of regions is changed, output game currency alert information.

The game currency alert information is configured to instruct the game table to give a game currency alert.

The second output module 1903 is configured to: in response to recognizing, based on the image frame sequence, that a game currency operating object associated with a preset object appears in the first region, output process alert information.

In some embodiments, the game currency information includes at least one of a game currency amount, or a game currency value.

In some embodiments, the first output module 1902 is further configured to: recognize game currency information in an i^{th} frame in the image frame sequence to obtain i^{th} piece of game currency information, i being a positive integer greater than 1; in response to that original game currency information in the original image frame is different from the i^{th} piece of game currency information, recognize a region among the plurality of multiple regions corresponding to a difference between the original game currency information and the i^{th} piece of game currency information as a first target region; and in response to determining, based on the first target region and the first region, that the game currency information of the first region is changed, output the game currency alert information.

In some embodiments, the first output module 1902 is further configured to perform the following operations. In response to that the first target region is the first region, (i−1)^{th} piece of game currency information in an (i−1)^{th} frame and an (i−1)^{th} change value are acquired. The (i−1)^{th} change value is configured to represent a number of continuous frames, corresponding to the (i−1)^{th} frame, in which the game currency information of the first region is changed relative to the original image frame. In response to that the i^{th} piece of game currency information is the same as the (i−1)^{th} piece of game currency information, the (i−1)^{th} change value is increased by a first preset value to obtain an i^{th} change value. In response to that the i^{th} change value is more than or equal to a first change threshold, it is determined that the game currency information of the first region is changed, and the game currency alert information is output.

In some embodiments, the first output module 1902 is further configured to: in response to that the i^{th} piece of game currency information is different from the (i−1)^{th} piece of game currency information, recognize a region among the plurality of multiple regions corresponding to a difference between the i^{th} piece of game currency information and the (i−1)^{th} piece of game currency information as a second target region; and in response to that the second target region is not the first region, increase the (i−1)^{th} change value by the first preset value to obtain the i^{th} change value.

In some embodiments, the first output module 1902 is further configured to: in response to that the second target region is the first region, determine an initial change value as the i^{th} change value.

In some embodiments, an event that the original game currency information in the original image frame is different from the i^{th} piece of game currency information in the i^{th} frame includes at least one of the following: an original game currency amount in the original image frame is larger than an i^{th} game currency amount in the i^{th} frame, or an original game currency value in the original image frame is higher than an i^{th} game currency value in the i^{th} frame. The operation of outputting the game currency alert information includes: outputting first game currency alert information. The first game currency alert information is configured to represent at least one of a game currency amount decrease or game currency value decrease of the first region.

In some embodiments, an event that the original game currency information in the original image frame is different from the i^{th} piece of game currency information in the i^{th} frame includes at least one of the following: an original game currency amount in the original image frame is smaller than an i^{th} game currency amount in the i^{th} frame, or an original game currency value in the original image frame is lower than an i^{th} game currency value in the i^{th} frame. The operation of outputting the game currency alert information includes: outputting second game currency alert information. The second game currency alert information is configured to represent at least one of a game currency amount increase or game currency value increase of the first region.

In some embodiments, the first output module 1902 is further configured to recognize an original game currency amount from the original image frame, and recognizing an i^{th} game currency amount from the i^{th} frame; in response to that the original game currency amount is different from the i^{th} game currency amount, determine that the original game currency information is different from the i^{th} piece of game currency information; and determine the region among the plurality of regions corresponding to the difference between the original game currency information and the i^{th} piece of game currency information as the first target region based on the original image frame and the i^{th} frame.

In some embodiments, the first output module 1902 is further configured to: in response to that the original game currency amount is the same as the i^{th} game currency amount, recognize an original game currency value from the original image frame, and recognize an i^{th} game currency value from the i^{th} frame; and in response to that the original game currency value is different from the i^{th} game currency value, determine that the original game currency information is different from the i^{th} piece of game currency information.

In some embodiments, the second output module 1903 is further configured to: in response to recognizing, based on the image frame sequence, that the game currency operating object associated with the preset object appears in the first region, switch a game state from the halt state to a payout state.

In some embodiments, the second output module 1903 is further configured to: in response to detecting that the game currency operating object appears in the first region in m continuous image frames before the i^{th} frame of the image frame sequence, recognize an operation direction of the game currency operating object, m being a positive integer greater than the first change threshold; and in response to that the operation direction is a preset direction, determine that the game currency operating object associated with the preset object appears in the first region, and outputting the process alert information.

In some embodiments, the first output module 1902 is further configured to: in response to determining, based on the image frame sequence and the original image frame, that the game currency information of the first region among the plurality of regions is unchanged, output game currency alert cancellation information. The game currency alert cancellation information is configured to instruct the game table to cancel the game currency alert.

In some embodiments, the first output module 1902 is further configured to perform the following operations. A p^{th} frame and a (p−1)^{th} keep value are acquired from the image frame sequence, p being a positive integer greater than i+1. In response to that game currency information of the first region in the original image frame is the same as game currency information of the first region in the p^{th} frame, the (p−1)^{th} keep value is increased by a second preset value to obtain a p^{th} keep value. The p^{th} keep value is configured to represent a number of continuous frames, corresponding to the p^{th} frame, in which the game currency information is the same as that in the original image frame. In response to that the p^{th} keep value is more than or equal to a second change threshold, it is determined that the game currency information of the first region is unchanged, and the game currency alert cancellation information is output.

In some embodiments, the acquisition module 1901 is further configured to perform the following operations. At least two video frame sequences in the halt state are acquired. The at least two video frame sequences are acquired by at least two cameras respectively arranged on the game table. The at least two video frame sequences are synthesized according to a temporal order to obtain the image frame sequence.

The embodiments of the disclosure provide an electronic device, which is configured to implement a method for detecting a game currency state in the method embodiment above. FIG. 13 illustrates a schematic diagram of a hardware entity of an electronic device according to an embodiment of the disclosure. As illustrated in FIG. 13, the electronic device 102 includes a memory 2001 and a processor 2002. The memory 2001 stores a computer program capable of running in the processor 2002. The processor 2002 executes the program to implement the steps in any above method for detecting a game currency state as described in the embodiments of the disclosure.

The memory 2001 is configured to store a computer program and application executed by the processor 2002, may also cache data (for example, image data, video data, voice communication data and video communication data) to be processed or having been processed by the processor 2002 and each module in a second edge AI node, and may be implemented by a flash or a Random Access Memory (RAM).

The processor 2002 executes the program to implement the steps of any abovementioned method for detecting a game currency state. The processor 2002 usually controls overall operations of the electronic device 102.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor. It can be understood that other electronic devices may also be used to realize functions of the processor. No limitation is set in the embodiments of the disclosure.

The computer-readable storage medium/memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic-surface memory, an optical disk, or a Compact Disc Read-Only Memory (CD-ROM), or may be any terminal including one or any combination of the abovementioned memories, such as a mobile phone, a computer, a tablet, and a personal digital assistant.

The embodiments of the disclosure provide a computer program product or a computer program, which includes computer instructions stored in a computer-readable storage medium. A processor of a computer device reads the computer instructions from the computer-readable storage medium and executes the computer instructions to enable the computer device to execute the method for detecting a game currency state as described in the embodiments of the disclosure.

In some embodiments, the executable instructions may be in form of a program, software, a software module, a script, or codes, may be compiled in any form of programming language (including a compiling or interpretive language, or a declarative or procedural language), and may be deployed in any form, including being deployed as an independent program or as a module, a component, a subroutine or another unit suitable for use in a computing environment.

As an example, the executable instructions may but not always correspond to a file in a file system, and may be stored in a part of a file that stores another program or data, for example, stored in one or more scripts in a Hyper Text Markup Language (HTML) document, stored in a single file dedicated to a discussed program, or stored in multiple collaborative files (for example, files storing one or more modules, subprograms or code parts).

As an example, the executable instructions may be deployed in a computing device for execution, or executed in multiple computing devices at the same place, or executed in multiple computing devices that are interconnected through a communication network and located at multiple places.

It is to be pointed out here that the above descriptions about the storage medium and device embodiments are similar to the descriptions about the method embodiment, and beneficial effects similar to those of the method embodiment are achieved. Technical details undisclosed in the storage medium and device embodiments of the disclosure are understood with reference to the descriptions about the method embodiment of the disclosure.

The above are only embodiments of the disclosure and not intended to limit the scope of protection of the disclosure. Any modifications, equivalent replacements, improvements and the like made within the spirit and scope of the disclosure fall within the scope of protection of the disclosure.

1. A method for detecting a game currency state, comprising:
acquiring an original image frame and acquiring an image frame sequence of a scene of a game table in a halt state, wherein a plurality of regions for placing game currency are provided on the game table, and the original image frame is acquired when placement of the game currency is completed;
in response to determining, based on the image frame sequence and the original image frame, that game currency information of a first region among the plurality of regions is changed, outputting game currency alert information; and
in response to recognizing, based on the image frame sequence, that a game currency operating object associated with a preset object appears in the first region, outputting process alert information.

2. The method of claim 1, wherein the game currency information comprises at least one of:
a game currency amount, or
a game currency value.

3. The method of claim 2, wherein in response to determining, based on the image frame sequence and the original image frame, that the game currency information of the first region among the plurality of regions is changed, outputting the game currency alert information comprises:
recognizing game currency information in an i^{th} frame in the image frame sequence to obtain i^{th} piece of game currency information, i being a positive integer greater than 1;
in response to that original game currency information in the original image frame is different from the i^{th} piece of game currency information, recognizing a region among the plurality of regions corresponding to a difference between the original game currency information and the i^{th} piece of game currency information as a first target region; and
in response to determining, based on the first target region and the first region, that the game currency information of the first region is changed, outputting the game currency alert information.

4. The method of claim 3, wherein in response to determining, based on the first target region and the first region, that the game currency information of the first region is changed, outputting the game currency alert information comprises:
in response to that the first target region is the first region, acquiring (i−1)^{th} piece of game currency information in an (i−1)^{th} frame and an (i−1)^{th} change value, wherein the (i−1)^{th} change value is configured to represent a number of continuous frames, corresponding to the (i−1)^{th} frame, in which the game currency information of the first region is changed relative to the original image frame;
in response to that the i^{th} piece of game currency information is the same as the (i−1)^{th} piece of game currency information, increasing the (i−1)^{th} change value by a first preset value to obtain an i^{th} change value; and
in response to that the i^{th} change value is more than or equal to a first change threshold, determining that the game currency information of the first region is changed, and outputting the game currency alert information.

5. The method of claim 4, further comprising:
in response to that the i^{th} piece of game currency information is different from the (i−1)^{th} piece of game currency information, recognizing a region among the plurality of regions corresponding to a difference between the i^{th} piece of game currency information and the (i−1)^{th} piece of game currency information as a second target region; and
in response to that the second target region is not the first region, increasing the (i−1)^{th} change value by the first preset value to obtain the i^{th} change value.

6. The method of claim 5, further comprising:
in response to that the second target region is the first region, determining an initial change value as the i^{th} change value.

7. The method of claim 3, wherein
an event that the original game currency information in the original image frame is different from the i^{th} piece of game currency information in the i^{th} frame comprises at least one of the following:
an original game currency amount in the original image frame is larger than an i^{th} game currency amount in the i^{th} frame, or
an original game currency value in the original image frame is higher than an i^{th} game currency value in the i^{th} frame; and
outputting the game currency alert information comprises:
outputting first game currency alert information, wherein the first game currency alert information is configured to represent at least one of a game currency amount decrease or game currency value decrease of the first region.

8. The method of claim 3, wherein:
an event that the original game currency information in the original image frame is different from the i^{th} piece of game currency information in the i^{th} frame comprises at least one of the following:
an original game currency amount in the original image frame is smaller than an i^{th} game currency amount in the i^{th} frame, or
an original game currency value in the original image frame is lower than an i^{th} game currency value in the i^{th} frame; and
outputting the game currency alert information comprises:
outputting second game currency alert information, wherein the second game currency alert information is configured to represent at least one of a game currency amount increase or game currency value increase of the first region.

9. The method of claim 3, wherein in response to that the original game currency information in the original image frame is different from the i^{th} piece of game currency information, recognizing the region among the plurality of regions corresponding to the difference between the original game currency information and the i^{th} piece of game currency information as the first target region comprises:
recognizing an original game currency amount from the original image frame, and recognizing an i^{th} game currency amount from the i^{th} frame;
in response to that the original game currency amount is different from the i^{th} game currency amount, determining that the original game currency information is different from the i^{th} piece of game currency information; and
determining the region among the plurality of regions corresponding to the difference between the original game currency information and the i^{th} piece of game currency information as the first target region based on the original image frame and the i^{th} frame.

10. The method of claim 9, further comprising:
in response to that the original game currency amount is the same as the i^{th} game currency amount, recognizing an original game currency value from the original image frame, and recognizing an i^{th} game currency value from the i^{th} frame; and
in response to that the original game currency value is different from the i^{th} game currency value, determining that the original game currency information is different from the i^{th} piece of game currency information.

11. The method of claim 1, further comprising:
in response to recognizing, based on the image frame sequence, that the game currency operating object associated with the preset object appears in the first region, switching a game state from the halt state to a payout state.

12. The method of claim 3, wherein in response to recognizing, based on the image frame sequence, that the game currency operating object associated with the preset object appears in the first region, outputting the process alert information comprises:
in response to detecting that the game currency operating object appears in the first region in m continuous image frames before the i^{th} frame of the image frame sequence, recognizing an operation direction of the game currency operating object, m being a positive integer greater than a first change threshold; and
in response to that the operation direction is a preset direction, determining that the game currency operating object associated with the preset object appears in the first region, and outputting the process alert information.

13. The method of claim 3, further comprising:
in response to determining, based on the image frame sequence and the original image frame, that the game currency information of the first region among the plurality of regions is unchanged, outputting game currency alert cancellation information, wherein the game currency alert cancellation information is configured to instruct the game table to cancel the game currency alert.

14. The method of claim 13, wherein in response to determining, based on the image frame sequence and the original image frame, that the game currency information of the first region among the plurality of regions is unchanged, outputting the game currency alert cancellation information comprises:
acquiring a p^{th} frame and a (p−1)^{th} keep value from the image frame sequence, p being a positive integer greater than i+1;
in response to that game currency information of the first region in the original image frame is the same as game currency information of the first region in the p^{th} frame, increasing the (p−1)^{th} keep value by a second preset value to obtain a p^{th} keep value, wherein the p^{th} keep value is configured to represent a number of continuous frames, corresponding to the p^{th} frame, in which the game currency information is the same as that in the original image frame; and
in response to that the p^{th} keep value is more than or equal to a second change threshold, determining that the game currency information of the first region is unchanged, and outputting the game currency alert cancellation information.

15. The method of claim 1, wherein acquiring the image frame sequence of the scene of the game table in the halt state comprises:
acquiring at least two video frame sequences in the halt state, wherein the at least two video frame sequences are acquired by at least two cameras respectively arranged on the game table; and
synthesizing the at least two video frame sequences according to a temporal order to obtain the image frame sequence.

16. An apparatus for detecting a game currency state, comprising:
a processor; and
a memory configured to store instructions which, when being executed by the processor, cause the processor to carry out the following:
acquiring an original image frame and acquire an image frame sequence of a scene of a game table in a halt state, wherein a plurality of regions for placing game currency are provided on the game table, and the original image frame is acquired when placement of the game currency is completed;
in response to determining, based on the image frame sequence and the original image frame, that game currency information of a first region among the plurality of regions is changed, outputting game currency alert information; and
in response to recognizing a game currency operating object associated with a preset object in the first region based on the image frame sequence, outputting process alert information.

17. The apparatus of claim 16, wherein the game currency information comprises at least one of:
a game currency amount, or
a game currency value.

18. The apparatus of claim 17, wherein in outputting the game currency alert information in response to determining, based on the image frame sequence and the original image frame, that the game currency information of the first region among the plurality of regions is changed, the processor is caused to perform the following:
recognizing game currency information in an i^{th} frame in the image frame sequence to obtain i^{th} piece of game currency information, i being a positive integer greater than 1;
in response to that original game currency information in the original image frame is different from the i^{th} piece of game currency information, recognizing a region among the plurality of regions corresponding to a difference between the original game currency information and the i^{th} piece of game currency information as a first target region; and
in response to determining, based on the first target region and the first region, that the game currency information of the first region is changed, outputting the game currency alert information.

19. The apparatus of claim 18, wherein in outputting the game currency alert information in response to determining, based on the first target region and the first region, that the game currency information of the first region is changed, the processor is caused to perform the following:
in response to that the first target region is the first region, acquiring (i−1)^{th} piece of game currency information in an (i−1)^{th} frame and an (i−1)^{th} change value, wherein the (i−1)^{th} change value is configured to represent a number of continuous frames, corresponding to the (i−1)^{th} frame, in which the game currency information of the first region is changed relative to the original image frame;
in response to that the i^{th} piece of game currency information is the same as the (i−1)^{th} piece of game currency information, increasing the (i−1)^{th} change value by a first preset value to obtain an i^{th} change value; and
in response to that the i^{th} change value is more than or equal to a first change threshold, determining that the game currency information of the first region is changed, and output the game currency alert information.

20. A non-transitory computer-readable storage medium having stored thereon a computer program that, when being executed by a processor, causes the processor to implement a method for detecting a game currency state, the method comprising:
acquiring an original image frame and acquiring an image frame sequence of a scene of a game table in a halt state, wherein a plurality of regions for placing game currency are provided on the game table, and the original image frame is acquired when placement of the game currency is completed;
in response to determining, based on the image frame sequence and the original image frame, that game currency information of a first region among the plurality of regions is changed, outputting game currency alert information; and
in response to recognizing, based on the image frame sequence, that a game currency operating object associated with a preset object appears in the first region, outputting process alert information.
